(19) United States
(12) Patent Application Publication
(10) Pub. No.: US 2019/0291229 A1
(43) Pub. Date: Sep. 26, 2019

(54) Improved Gauge System

(71) Applicant: OMICRON PERSEI 8 ENTERPRISES PTY LTD AS TRUSTEE OF THE OMICRON PERSEI 8 ENTERPRISES TRUST, Dandenong South Victoria (AU)

(72) Inventor: Bojan Trabonjaca, Dandenong South, Victoria (AU)

(21) Appl. No.: 16/345,611

(22) PCT Filed: Oct. 27, 2016
(86) PCT No.: PCT/AU2016/051012

§ 371 Date: Apr. 26, 2019

(51) Int. Cl. B23Q 17/22; G01B 5/00; B23Q 16/00

(52) U.S. Cl. CPC B23Q 17/22; G01D 5/34753; B23Q 16/001; G01B 5/0004

(57) ABSTRACT

A linear gauge system for locating adjacent a weight bearing elongated frame able to support an elongated product which is to be processed linearly, the linear gauge system including a linear gauge, wherein the linear gauge is made precisely from a lightweight material; b. an elongated support wherein the elongated support is formed of stronger material than the linear gauge; and c. a carriage mounted on the linear gauge to which is mounted a movable platform which can engage a workpiece on the adjacent weight bearing elongated frame; wherein the linear gauge is formed precisely separately to the elongated support and mounted to the elongated support to provide the strength to the linear gauge.

### FIELD OF THE INVENTION

The present invention relates to an improved gauge system for positioning workpieces made of wood, plastic, metal or other material which require precision cutting. In particular the present invention relates to an improved gauge system which allows precision cutting and lightweight construction.

### BACKGROUND OF THE INVENTION

Positioning systems, also termed gauge systems, are used in a manufacturing environment to position workpieces quickly and accurately relative to a processing tool, such as a saw. The workpieces can be elongated articles such as pieces of lumber, pipes, conduits, sheet metal, extrusions, or the like.

In gauge systems, there can be stop-based gauge systems that have a stop which serves as a movable fence that contacts an end (or other surface) of a workpiece. By precise positioning of the stop there is established a precise distance along the elongated workpiece from the end to the processing tool. The stop can be driven along a linear axis (i.e., a measurement axis) to adjust the distance of the stop from the tool according to a target dimension for a product to be formed by processing the workpiece with the tool, such as the length to be cut from a piece of lumber.

Stop-based, linear gauge systems can have various levels of complexity.

A fundamental stop gauge system requires a precise elongated linear gauge or measuring ruler so as to be able to define positions along the elongated stop gauge system at exact locations relative an end. In this way the workpiece supported along the stop gauge system can be linearly processed.

However as shown in FIG. 1 the stop gauge system 11 comprises a combined gauge and support 15 upon which is movably mounted a movable stop 20 that must glide along the combined gauge and support 15 and along or against the workpiece 10.

The first fundamental problem is that the whole mechanism and support of the movable stop 20 and workpiece 10 is tightly mounted on a large combined gauge and support 15 as there must be minimization of wobble or tilt or relative fitting of movable stop 20 to the combined gauge and support 15 otherwise the accuracy of the location of the movable stop 20 is not provided by the accuracy of the accurate gauge of the combined gauge and support 15

The second fundamental problem is that since the gauge must be made precisely to give the measuring accuracy, the combined gauge and support 15 must be made precisely.

A third fundamental problem is the weight to be supported and the accuracy of control and the complexity of structure of the combined gauge and support results in the need for a detailed and complex bearing structures to engage therebetween.

It can be seen that there are a number of problems and these and others problems multiply in a chain reaction of problematic effects.

In one prior art version 12 as shown in FIG. 2 the stop gauge system 12 comprises a combined gauge and support 16 upon which is movably mounted a movable stop 21 that must glide along the combined gauge and support 16 and have an arm (not shown) that extends along or against the workpiece 10. The movable stop 21 in this form is generally T shape with the central support being held within the combined gauge and support 16 and engaging by bearings 25 therebetween.

When this version 12 is made from expensive material such as aluminium, it needs to have a complex extruded shape to allow such a lightweight material to maintain strength as well as minimizing the amount of aluminium material to save costs as well as to maintain the accuracy of the combined gauge and support.

Therefore as shown in FIG. 3 the combined gauge and support 16 is formed from a complex moulded or extruded aluminium shape with a plurality of detailed connectors joining the various parts together. It is clear that maintaining accuracy requires a detailed precision in manufacture and construction and that these precise structures can readily deteriorate in use by wear or misalignment at a multitude of connecting points.

In another prior art version 13 as shown in FIG. 4 the stop gauge system 13 comprises a combined gauge and support 17 upon which is movably mounted a movable stop 22 that must glide along the combined gauge and support 17 and have an arm (not shown) that extends along or against the workpiece 10. Instead of the movable stop 21 only having a single central support of the generally T shape being held within the combined gauge and support 16 and engaging by bearings 25, an improvement to minimize wobble and tilting is to have an inverted U-shape movable stop 22 extending over the top of combined gauge and support 17. Bearings 26 are mounted between the outside of the combined gauge and support 17 and the inner underside of the wings of the inverted U-shape movable stop 22.

When this version 13 is made from expensive material such as aluminium, it needs to have a complex extruded shape to allow such a lightweight material maintain strength as well as minimizing the amount of aluminium material to save costs. However as shown in FIG. 5 the strength of the combined gauge and support 16 must provide a stronger spaced structure combined gauge and support 16 with perfect alignment and precision making of the four connected corners. Further with the gauge bearings 26 being spaced there must be more accuracy in complex bearings to align at a distance and to be more precisely constructed to provide the required support of the entire weight while providing the accuracy of measurement of location by the gauge to the movable stop without wobble or tilt or misalignment or relative movements.

More sophisticated versions of stop gauge systems automate control of the tool and use the stop as a pusher to drive movement of the workpiece toward the tool. These pusher-based systems can, for example, drive the end of a workpiece toward the tool to multiple stopped positions at which workpiece processing is performed, to create multiple products automatically from a single workpiece. For example, pusher-based systems can create a set of products of desired length automatically based on a cut list. In contrast, simpler stop-based gauge systems combine (a) a passive stop that does not push the workpiece and (b) manual control of the tool. With these simpler systems, a user manually places a workpiece against the stop after the stop has ceased moving at a location defined by a target dimension, and then manually controls the tool to process the workpiece.

Stop-based, linear gauge systems improve efficiency and accuracy, thereby saving time and money. Accordingly, many craftsmen, such as framers, finish carpenters, cabinet installers, and cabinetmakers, would benefit from use of these gauge systems. However, these craftsmen frequently do not work predominantly in a single facility, but instead may move frequently between different job sites.

As a result, craftsmen often opt not to invest in stop-based gauge systems because these systems having perceived problems including one or more of:
a. lack of portability,
b. high cost,
c. large size,
d. need for heavy duty precision elongated guide that supports all of the items and workpiece
e. need for heavy duty precision elongated guide which while providing support also provides precision mounting and precision measuring
f. complexity of use,
g. lack of functionality, and
h. difficulty to assemble and maintain.

Therefore, improved stop-based gauge systems are needed that include one or more improvements related to one or more of the benefits of:
a. more portable,
b. less expensive,
c. more compact,
d. safer.
e. less complex,
f. does not require the whole article to be heavy duty supporting
g. does not require the whole article to be precision made
h. more functional, and/or
i. more user-friendly to assemble, operate, reconfigure, and/or service.

In view of the above, it is desirable to have an improved lightweight gauge system that addresses and ameliorates one or more of the prior art deficiencies or at least provides one or more viable options.

It is to be understood that, if any prior art information is referred to herein, such reference does not constitute an admission that the information forms part of the common general knowledge in the art, in Australia or any other country.

### SUMMARY OF THE INVENTION

According to the invention there is provided a linear gauge system for locating adjacent a weight bearing elongated frame able to support an elongated product which is to be processed linearly, the linear gauge system comprising: a linear gauge, wherein the linear gauge is made precisely from a lightweight material; an elongated support wherein the elongated support is formed of stronger material than the linear gauge; and a carriage mounted on the linear gauge to which is mounted a movable stop which can engage a workpiece on the adjacent weight bearing elongated frame, wherein the linear gauge is formed precisely separately to the elongated support and mounted to the elongated support to provide the strength to the linear gauge.

It can be seen that the invention has the benefit of separating the linear gauge from the support.

This allows the linear gauge alone to be precisely made from predominately aluminium. At the same time it allows the elongated support to be formed less precisely of steel and not requiring complex interfittings or complex bearings. This clearly represents an improvement over the prior art complex systems, and less expensive.

The linear gauge system can have the elongated support formed as a strong hollow structure such as formed by at least two sections such as L sections that interfit to form the hollow structure.

In this form of the linear gauge system the linear gauge can be mounted at least substantially within the elongated support. In this way the elongated support is not only providing the strength to the structure but is protecting the precisely formed linear gauge in a spaced protective manner rather than needing to interface with it in any precision.

In a preferred linear gauge system the carriage is generally inverted U-shape over the linear gauge and within the elongated support and engaging by bearings therebetween. The ability to have a small precise linear gauge means that unlike the prior art the inverted U-shape is also relatively small as it merely fits over the linear gauge but is within the elongated support.

According to a further aspect of the present invention there is provided a linear gauge system comprising:
a. a linear gauge having precision measurements
b. a weight bearing elongated frame located adjacent to the linear gauge
c. a movable platform mounted on the weight bearing frame enabling travel along the elongated frame
d. a drive means for driving the movable platform
e. a control means for controlling the movement of the platform along the platform according to precise measurement determined according to the linear gauge
   wherein a device can be mounted on the movable platform and the control means can accurately locate the device at precise measurements along the elongated frame according to the precision measurements of the linear gauge.

The present invention represents an advance over the prior art because it is lightweight and therefore easily portable, and

Preferably the linear gauge is precision engineered from lightweight material. In one embodiment the lightweight material can be thin aluminium.

In one embodiment the linear gauge is preferably mounted on the weight bearing elongated frame.

The weight bearing elongated frame can substantially overly the linear gauge. Alternatively, the weight bearing elongated frame can substantially enclose the linear gauge.

The linear gauge system of the invention can include a casing which substantially encloses the weight bearing elongated frame and the linear gauge.

In one preferred aspect of the invention, a portion of the movable platform can extend away from the weight bearing frame and is able to support the device mounted on the carriage. Preferably, a portion of the movable platform extends from the casing away from the weight bearing frame and is able to support the device mounted on the carriage.

In one embodiment of the invention, the movable platform can be mounted on the weight bearing frame enabling travel along the elongated frame. Preferably, the movable platform is mounted to a linear gauge carriage travelling along the linear gauge in a substantially non-weight bearing manner enabling precision travel along the linear gauge.

In a preferred aspect of the linear gauge system, the linear gauge carriage can substantially overly the linear gauge. Preferably the linear gauge carriage is a substantially inverted U-shape which overlies the linear gauge.

Preferably the linear gauge carriage of the linear gauge system is adapted to substantially glide along the linear gauge. In particular the linear gauge carriage can be adapted to substantially glide along the linear gauge along elongated bearings.

The drive means of the linear gauge system can be mounted on the movable platform to drive it along the weight bearing frame.

In one embodiment the drive means can be mounted on the weight bearing frame and connected to the movable platform to drive it along the weight bearing frame.

In a further embodiment, the drive means can be mounted alongside the weight bearing frame and includes a motor driving an elongated member connected to the movable platform to selectively locate the movable platform along the weight bearing frame.

The drive means of the linear gauge system can be mounted to the weight bearing frame and includes a motor driving an elongated member extending in a continuous loop around spigots at or near spaced ends of the weight bearing frame and connected to opposing sides of the movable platform to selectively locate the movable platform along the weight bearing frame. It can be seen that the invention provides the following benefits including:
a. The linear gauge is precision engineered from lightweight material.
b. The linear gauge is substantially non-weight bearing hence can be made from material such as aluminium,
c. Greater precision on linear gauge for locating a device for performing work in a work piece

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 is a general diagrammatic detail of a gauge system of the prior art having a a combined gauge and support;

FIGS. 2 and 3 are general diagrammatic and typical cross section of a complex gauge system of the prior art having a combined gauge and support which supports a general T-shaped movable stop;

FIGS. 4 and 5 are general diagrammatic and typical cross section of a complex gauge system of the prior art having a combined gauge and support which supports a general inverted U-shaped movable stop;

FIGS. 6 and 7 are general diagrammatic and typical cross section of a linear gauge system of an embodiment of the invention having a gauge mounted within an elongated support which supports a general inverted U-shaped carriage connectable to an external movable stop;

FIG. 9 is an overhead diagrammatic view of the components of an embodiment of the overall linear gauge system of the invention;

FIG. 10 is a diagrammatic cross sectional view of the components of an embodiment of the overall linear gauge system of the invention as per FIG. 8;

FIG. 11 is a diagrammatic cross sectional view of the components of a further embodiment of the overall linear gauge system of the invention which due to the configuration can be more compactly packaged by partial overlapping compared to the embodiment of FIG. 9;

FIG. 12 is a perspective view of components of the linear gauge system in accordance with an embodiment of the present invention,

FIG. 13 is an exploded view of components of the linear gauge system in accordance with an embodiment of the present invention,

FIG. 14 is a perspective view of two opposite end lengths of an assembled length of the linear gauge system in accordance with an embodiment of the present invention and identifying sections A, B and C;

FIG. 15 shows a close-up cross-sectional view of the linear gauge system at A in FIG. 14 in accordance with an embodiment of the present invention;

FIGS. 16 and 17 show a close-up perspective view of part ‘A’ of the linear gauge system in FIG. 14,

FIGS. 18 and 20 show close-up perspective views of part ‘B’ of the linear gauge system in FIG. 13 with a close-up perspective view of a motor for driving an continuous drive belt of the linear gauge system in accordance with an embodiment of the invention;

FIGS. 19 and 21 show a close-up perspective views of part ‘C’ of the linear gauge system in FIG. 13 a close-up perspective view of an a end roller mount of the continuous drive belt of the linear gauge system in accordance with an embodiment of the invention;

FIG. 22 is an overhead view of a section of the linear gauge showing movable platform of the linear gauge system,

FIG. 23 is a perspective view of positioning system on the linear gauge for locating the movable platform,

FIG. 24 is a flow diagram showing processing features for working the linear gauge system of the invention.

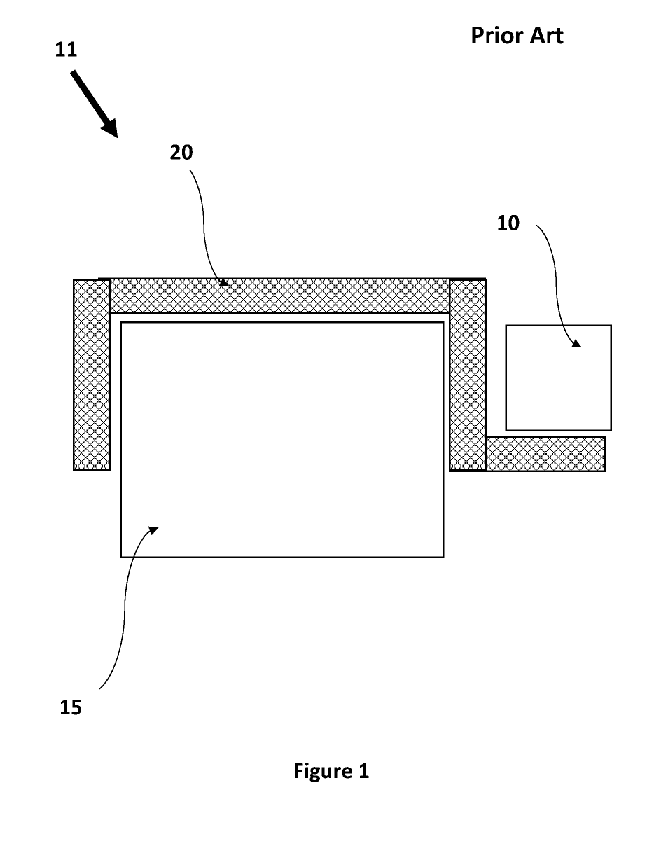

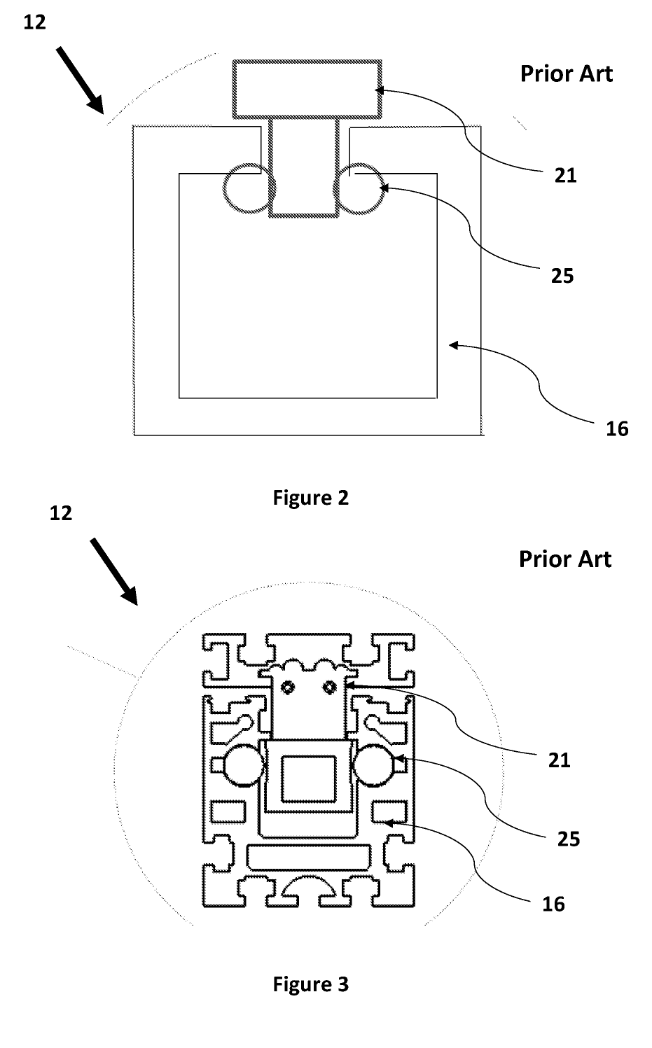

### DESCRIPTION OF PREFERRED EMBODIMENTS

It should be noted in the following description that like or the same reference numerals in different embodiments denote the same or similar features.

Referring to the drawings there is shown a lightweight linear gauge system 30 for accurately positioning a device such as a cutting tool relative to a workpiece supported on a support surface such as a conveyor 81 (best seen in FIG. 11) for precision work on the work piece.

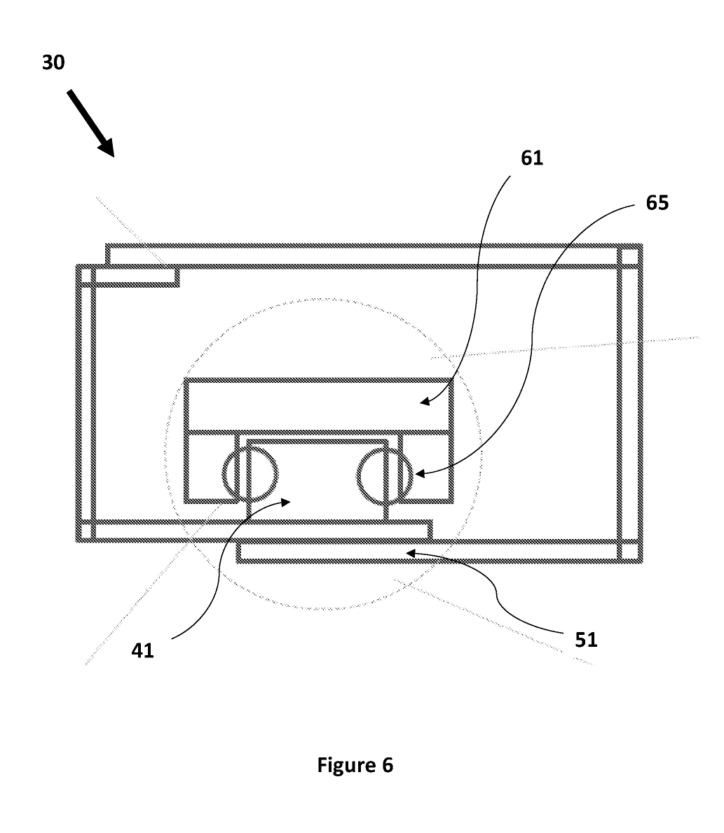

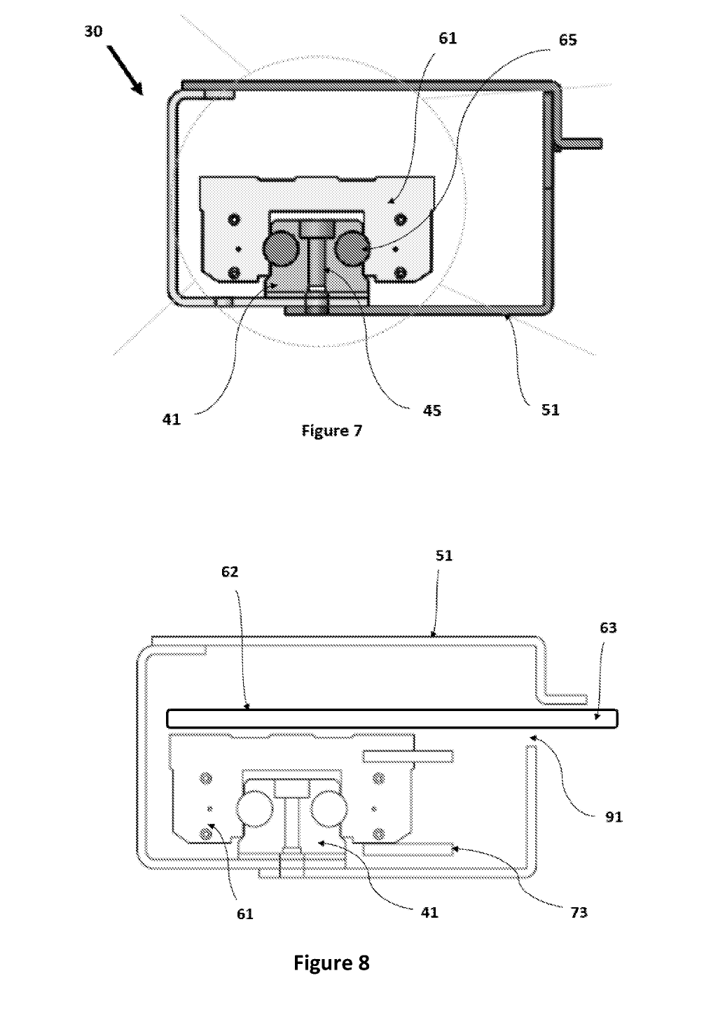

As shown in FIGS. 6 and 7, the linear gauge system 30 broadly comprises a linear gauge 41 forming a rail made of precision lightweight material mounted to a weight bearing elongated support frame 51 made from heavier grade material such as steel.

The linear gauge 41 is mounted to the support frame 51 by a series of spaced apart bolts 45 passing through a central portion of the linear gauge and fastening to a floor portion of the support frame. In FIG. 6 the elongated support frame 51 is a strong hollow structure formed by at least two L-sections that interfit to form the hollow structure.

The linear gauge system further includes a carriage 61 movably mounted on the linear gauge 41 over bearings 65 on the linear gauge. The linear gauge 41 is formed precisely and separately to the elongated support frame 51, and mounted to the elongated support frame to provide the strength to the linear gauge.

In FIGS. 6 to 8, 13 and 15 the carriage 61 is generally an inverted U-shape over the linear gauge and within the elongated support, engaging the linear gauge by bearings therebetween. The ability to have a small precise linear gauge means that unlike the prior art the inverted U-shape is also relatively small as it merely fits over the linear gauge but is within the elongated support. This also means that instead of the linear gauge providing the strength and weight bearing features as in the prior art, the linear gauge of the present invention is smaller, less complex, higher precision, lighter hence portable, and less expensive to make from aluminium.

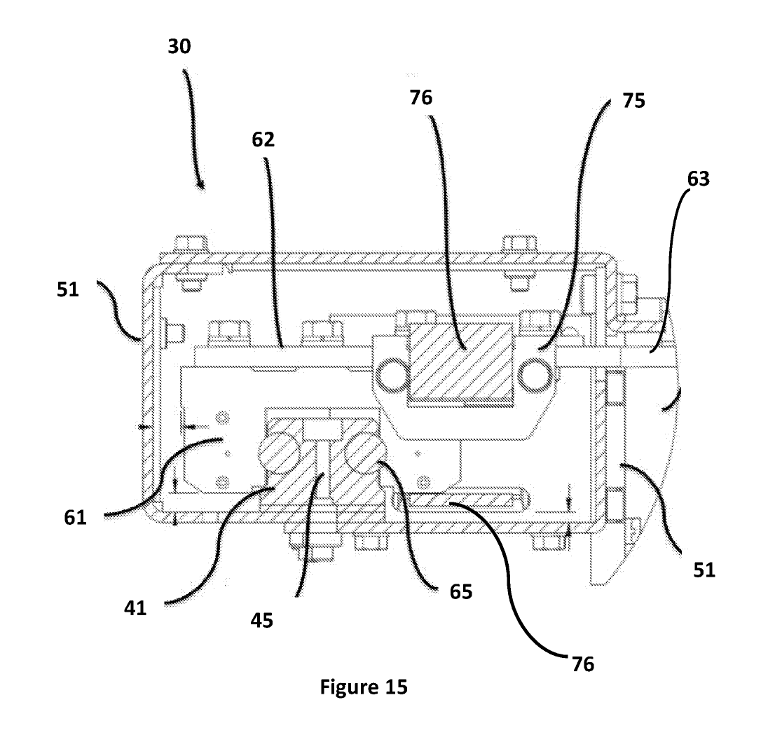

As seen in FIGS. 8 to 11, and 15, the linear gauge system 41 further includes a platform 62 mounted on the carriage 61, which is adapted to engage a workpiece on the weight bearing elongated frame. In the embodiment shown in FIGS. 8 and 15, a portion of the platform extends away from the weight bearing frame and is able to support a device mounted on the carriage.

In particular as shown in FIGS. 8 and 15, the weight bearing elongated support frame 51 includes a slot 91 extending along the elongate support frame 51 receiving an edge portion 63 of the platform 62 therethrough, wherein as the carriage 61 moves along the linear gauge 41, the platform moves relative to the slot 91 to position the edge portion.

The edge portion 63 of the platform protrudes through the slot 91 to provide a support platform for receiving a workpiece thereon, and moves along the slot with the carriage for precise positioning of the workpiece relative to a processing tool (not shown).

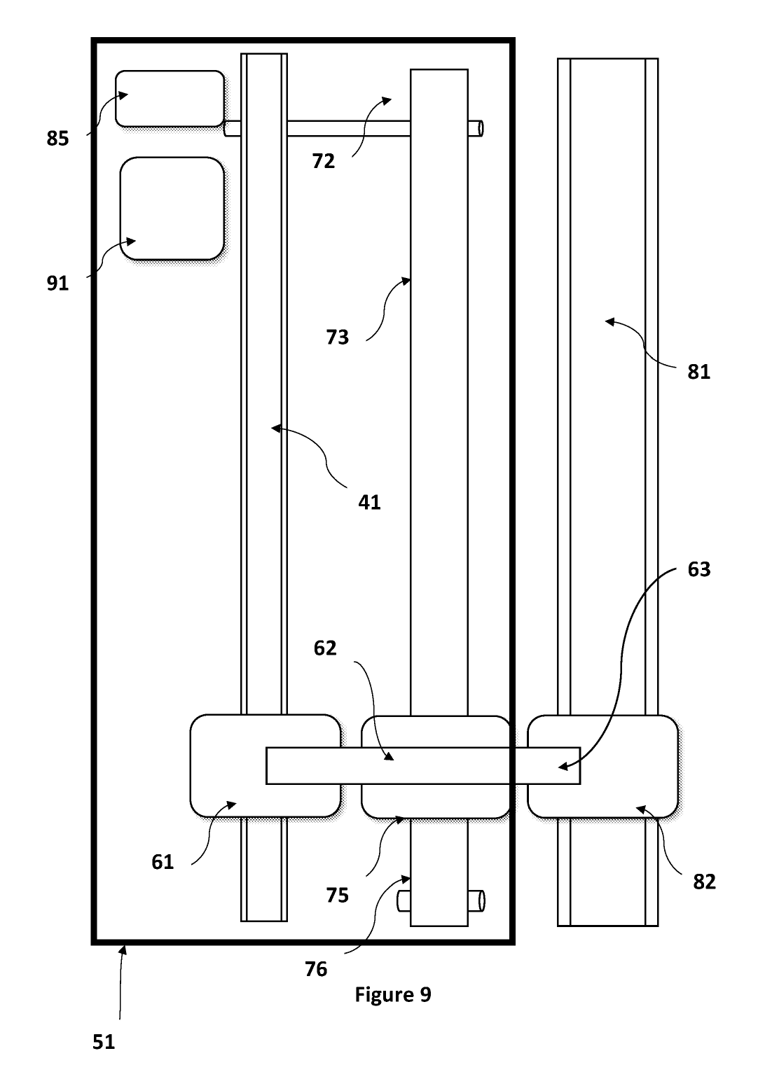

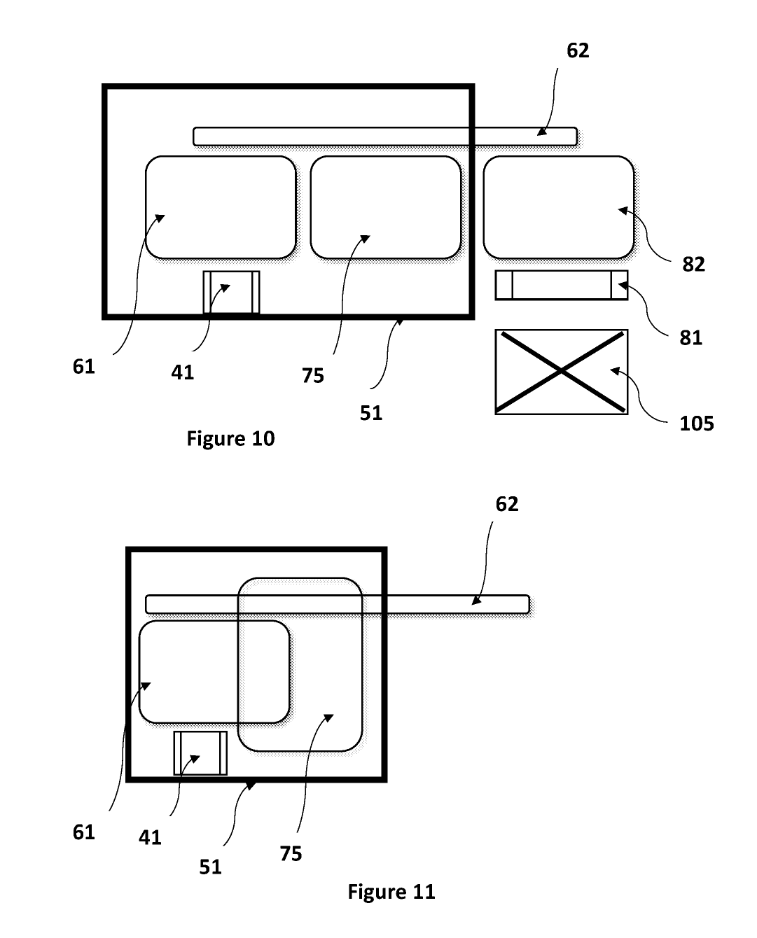

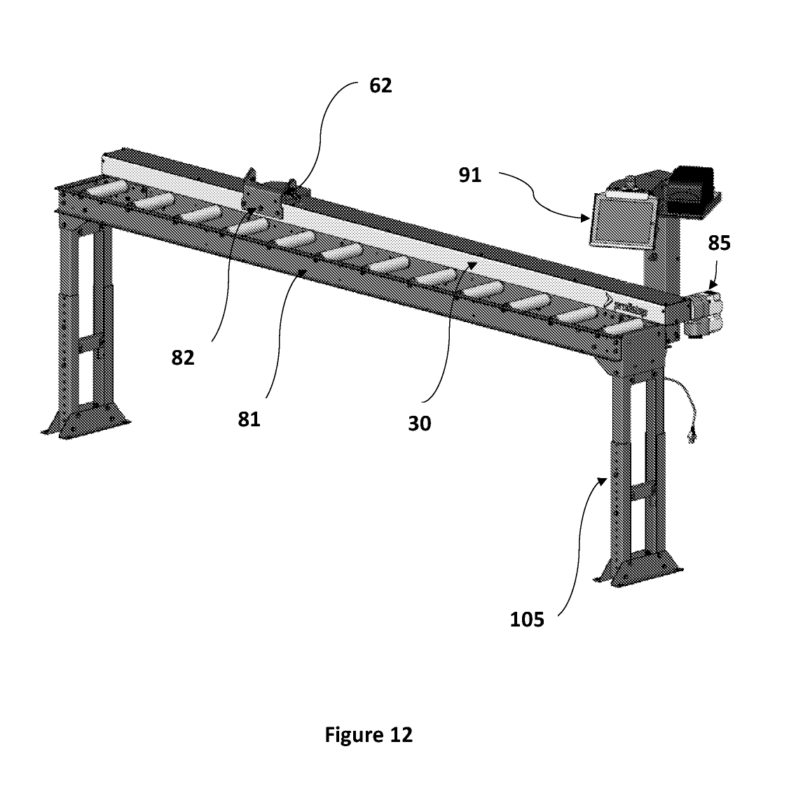

As shown in FIGS. 9 to 12, 15 and 17, the linear gauge system 30 further includes a drive means 75. In FIGS. 9 to 11 and 15 the drive means 75 is provided in the form of a belt drive system comprising a belt loop drive 76 and a drive motor 85. Several alternative arrangements are shown in FIGS. 9 to 11 where the belt loop 76 of the belt drive is either offset from the linear gauge 41, overlaps with the linear gauge 41, or is configured in parallel with the linear gauge 41. As shown in FIGS. 10 and 12 the gauge system 30 can be mounted to a conveyor structure 81 having a series of spaced rollers on a conveyor platform and height adjustable legs 105. In this embodiment the platform 62 also includes a mounting plate 82 to which a processing device such as a cutting tool or a workpiece can be attached.

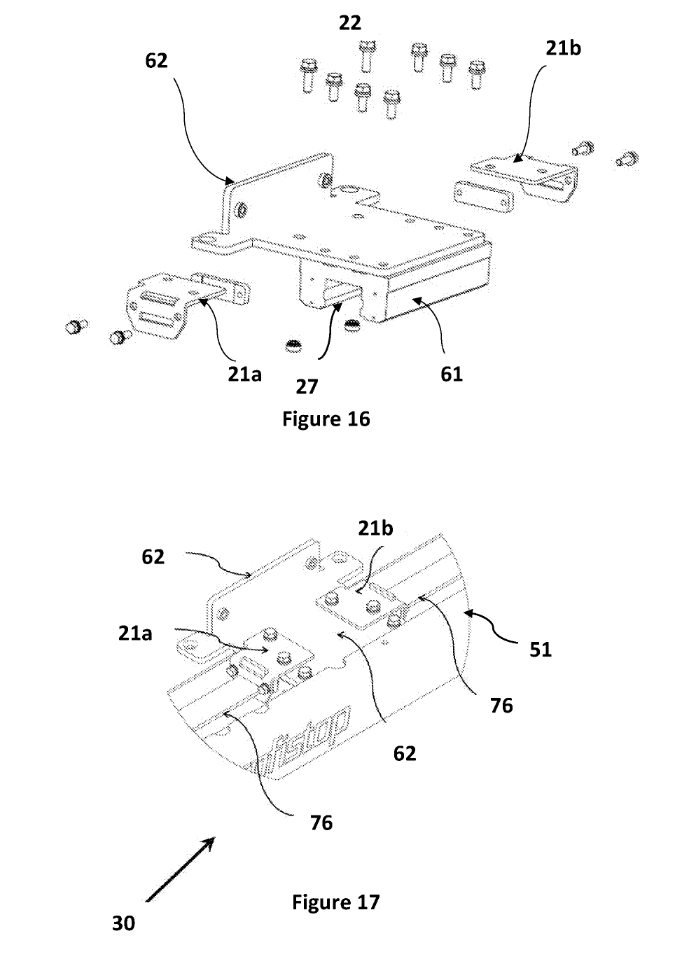

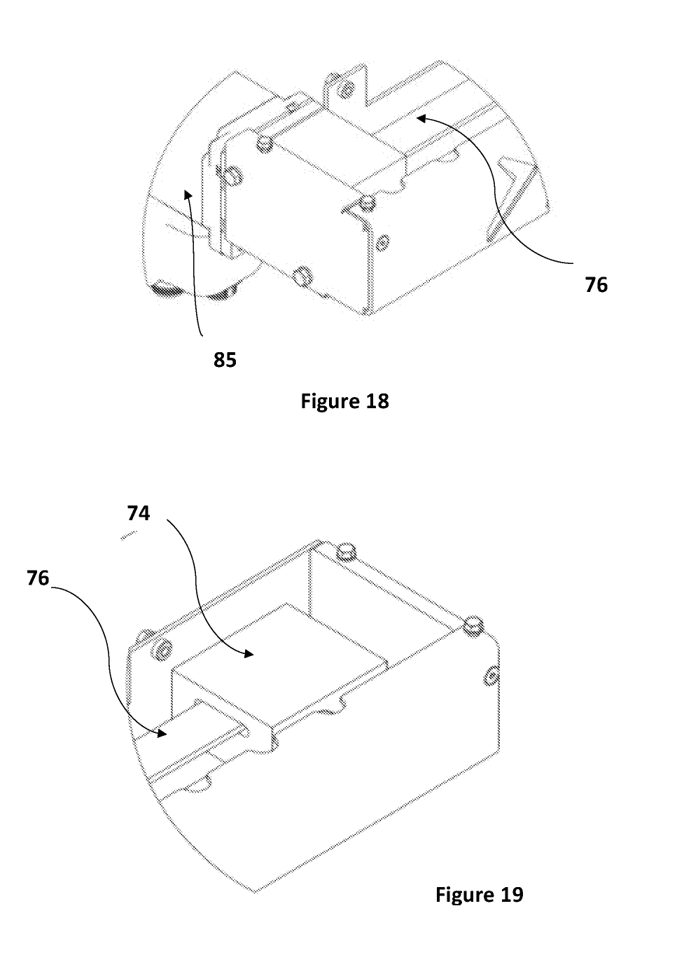

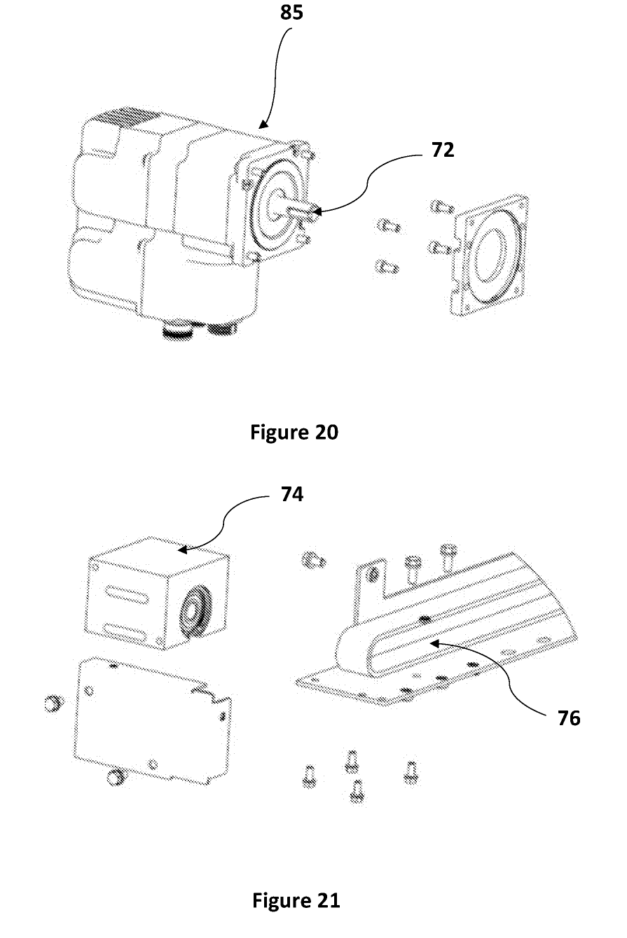

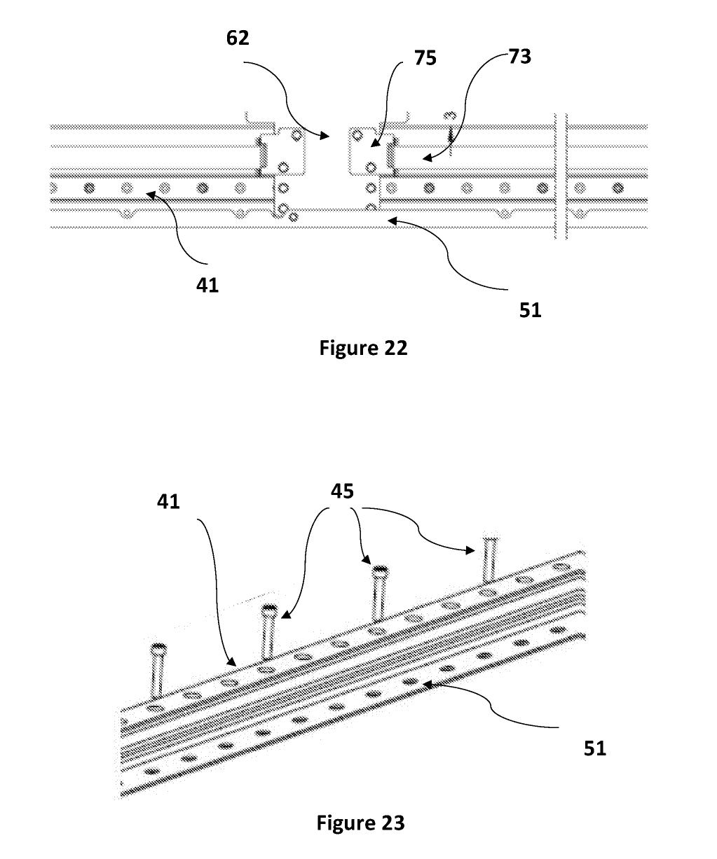

As best shown in FIGS. 16 and 17, the belt loop drive 76 includes a pair of opposite buckles 21a and 21b adapted to be fixed to opposite sides of the platform 62 by aligned openings in a mounting part of the buckles and the platform 62 and fastening by means of through bolts 22.

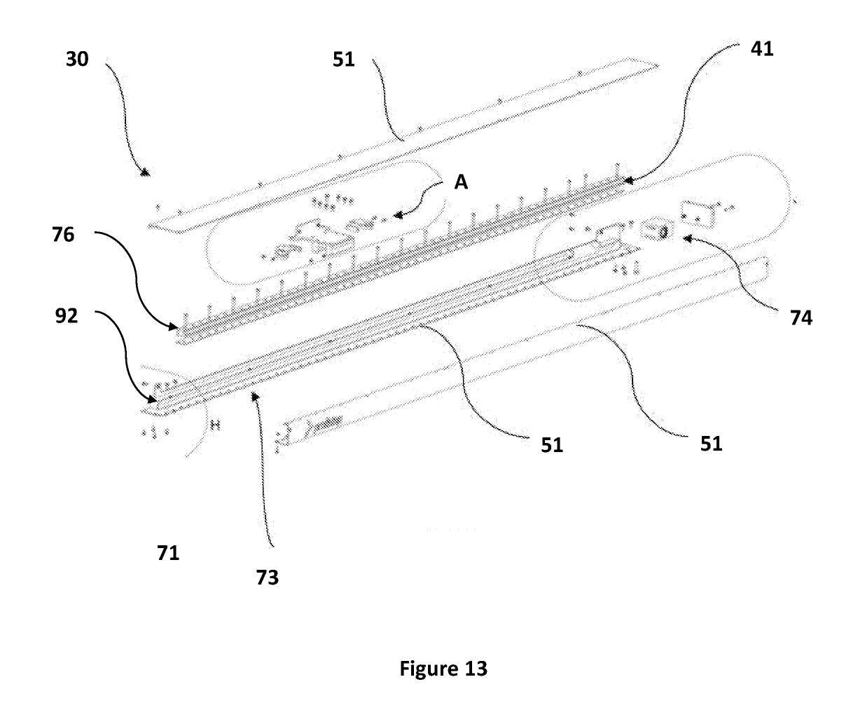

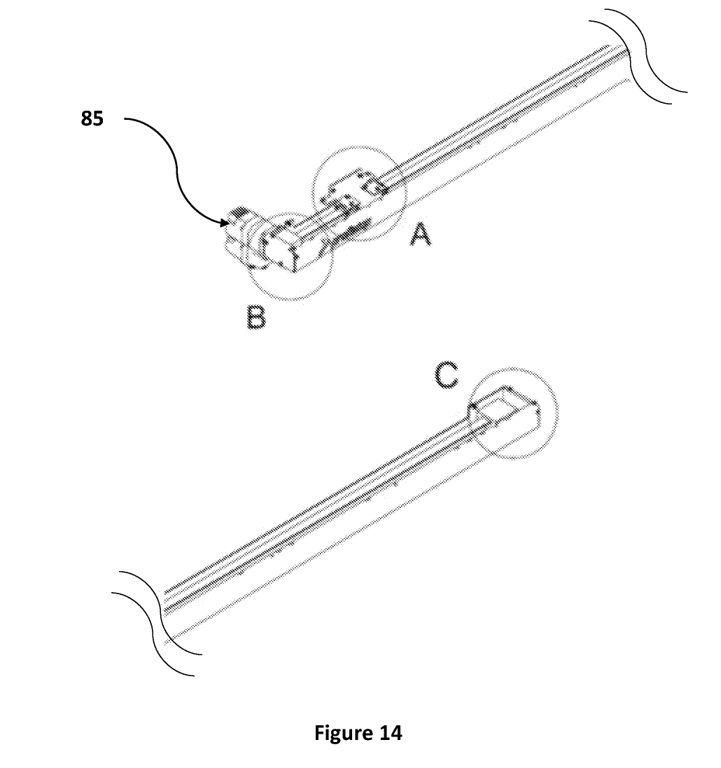

As seen in FIG. 17, the buckles 21a and 21b are fitted with end portions of a belt 76, and the belt thus forms a loop structure (see FIG. 13) which is driven in a looped pathway by a drive motor 85 through which the belt engages and passes. In one embodiment shown in FIGS. 12 and 14 the motor is located externally on one end of and offset from the elongate support frame.

The linear gauge 41 is fabricated from a lightweight material such as aluminium thus reducing the weight of the linear gauge system 1 and labor costs for manufacture.

The linear gauge system 30 further includes a control system 91 which controls movement and positioning of the platform 62 along the support frame according to precise measurement of the linear gauge 41. In one embodiment a device can be mounted on the movable platform and the control means accurately locates the device at precise measurements along the elongated frame according to the precision measurements of the linear gauge.

The control means comprises an operating system which controls the positioning of the movable platform 62 along the linear gauge 41 according to predetermined measurement requirements and location information according to the linear gauge.

The drive means in one embodiment shown in FIG. 12 is functionally operated by a control operating system 91. This system includes a gradation system comprising a series of spaced apart openings on the linear gauge 41 extending along the length of the linear gauge at predetermined spacings, light emitting devices for dispersing light through the spaced openings, light sensing devices for detecting light through the openings, and a communication system for receiving and relaying information from the light sensing devices to a motor control.

As shown in FIGS. 10 to 11b as the movable platform traverses the linear gauge, at least a part of the platform covers one or more adjacent openings for a given location. Light detection changes are sensed by light detectors located on or close to the linear gauge and information transferred to an operating central control unit 31. The central control unit programmed for determining location of the platform relative to the linear gauge.

Turning to FIGS. 12 and 13 the linear gauge 41 of the linear gauge system 30 includes a longitudinal shaped linear gauge 41 mounted to and extending along a floor portion of the elongate support 51 by spaced apart fastening bolts 45.

The platform 62 of the linear gauge system 30 is received by and movable over the weight bearing frame 51 by drive means 75 located offset to and above the linear gauge 41. In the figures the drive means includes a motor 85 mounted to and externally of the elongate support frame 51 and being interconnected to the continuous drive belt 76 forming a looped circuit. As shown the continuous belt 76 is connected to a part of the platform 62 by mounting buckles. The belt extends in a continuous loop around spigots 72, 74 at or near spaced ends of the weight bearing frame and connected to opposing sides of the platform by the mounting buckles to enable selective positioning of the platform by moving the carriage along the linear gauge with the weight bearing being provided by the elongate support frame 51.

As shown the movable 62 is mounted to a linear gauge carriage 61, wherein the linear gauge carriage 61 has an internal longitudinal inverted U-shaped recess 27 with a complimentary cross-section to the linear gauge 41. As shown in the figures, the linear gauge carriage 61 is adapted to move over the linear gauge, and in so doing displace the platform along the elongate support frame extending through slotted opening 91 with bearings 65 aiding the sliding movement of the carriage 61 relative to the linear gauge.

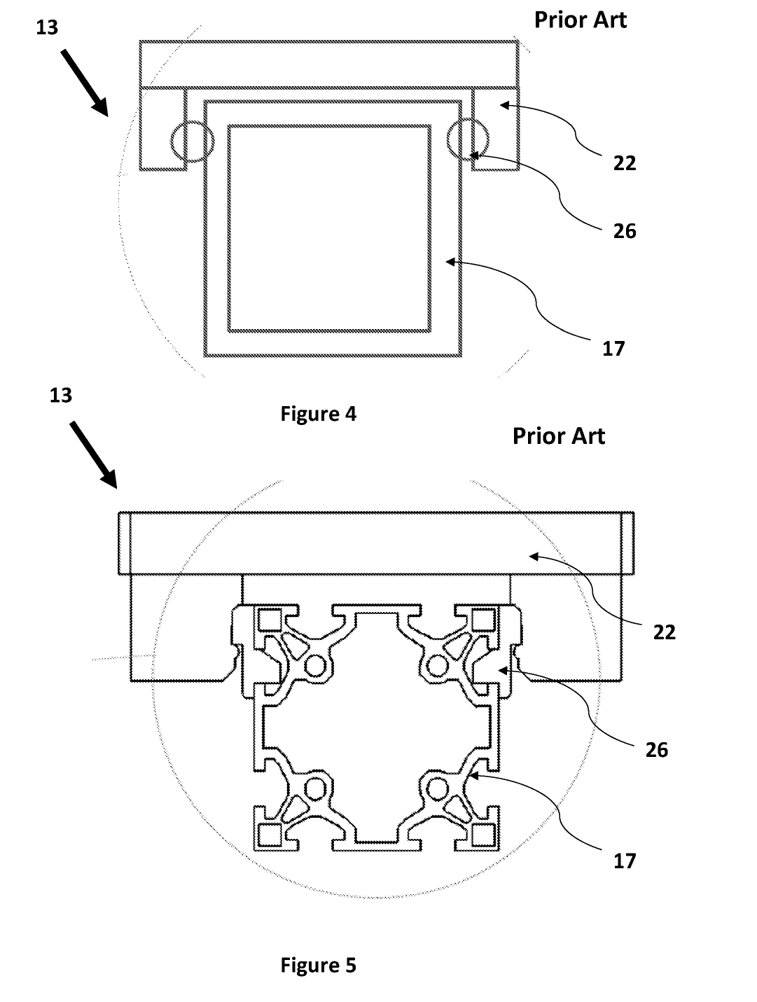

In a further embodiment shown in FIG. 4, the platform includes an upright support plate 82 that extends away from the weight bearing frame 51. In combination the upright support plate and platform provide support for a device such as a cutting tool on the linear gauge carriage 61.

The linear gauge 41 in one embodiment substantially overlies the linear gauge 41. In an alternative embodiment the weight bearing elongated frame substantially encloses the linear gauge.

The linear gauge system includes a drive means including a continuous belt fixed to the platform, and a motor for driving the platform 62 and carriage via the continuous belt. A control means 91 controls the movement of the platform 62 by the drive means along the elongate frame over the linear gauge 41 according to precise measurement determined according to the control system.

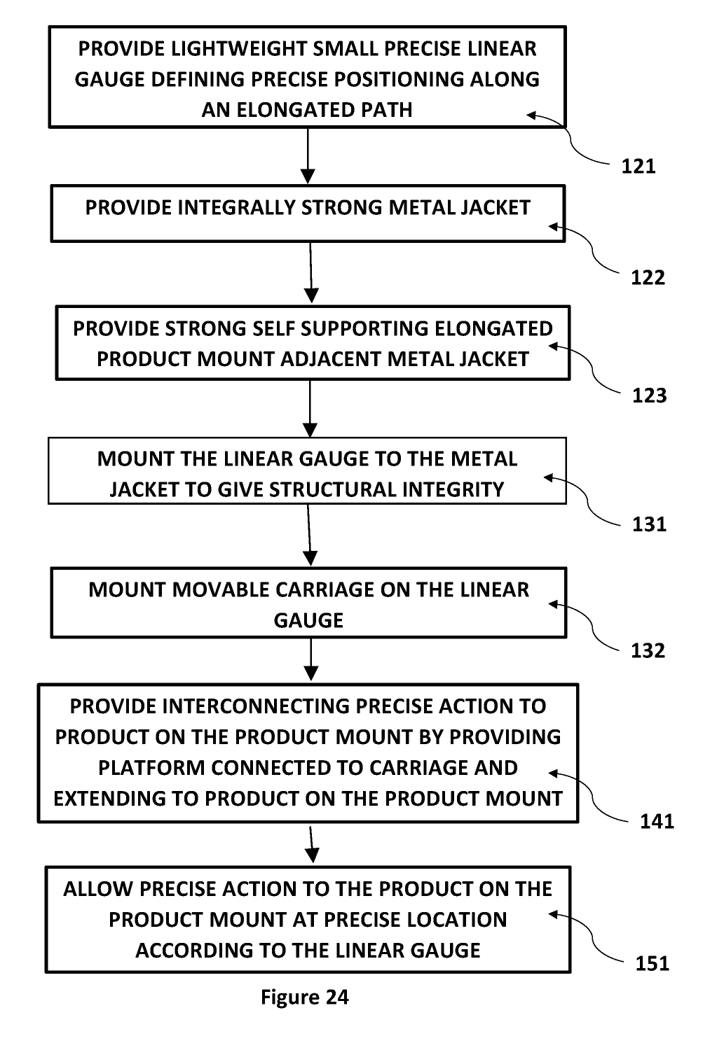

Referring to FIG. 24, there is shown a process and method for precise positioning and cutting using a linear gauge system according to the present invention. The process includes providing a small lightweight aluminium gauge 121 having precision measurements along an elongated path. The lightweight gauge is mounted along a floor portion of a heavier self-supporting elongate support jacket or frame 122. The support jacket 122 can be formed from a single or multi-component structure and the gauge is attached to the support to provide structural integrity for the lightweight gauge. The support jacket also includes a longitudinal slotted opening to receive and allow free movement of a platform. A movable carriage 132 having a complementary receiving structure is mounted to the gauge to allow movement of the carriage along the gauge. A support platform 141 is mounted to the carriage and at least a portion of the platform extends through the slotted opening in the elongate support jacket. The system includes a drive means, a gradation system, and a control means 151 in communication with the gradation system operable to control the drive means.

The drive means includes a continuous belt affixed to the platform, and a motor adapted to drive the belt and therefore move the carriage along the gauge to alter the position of the platform along the elongate support.

The gradation system includes a series of spaced apart openings on the linear gauge 41 extending along the length of the linear gauge at predetermined spacings, light emitting devices for dispersing light through the spaced openings, light sensing devices for detecting light through the openings, and a communication system for receiving and relaying information from the light sensing devices to the control means. The control means receives input data for locating a work piece or a processing tool on the platform at a predetermined location along the elongate support jacket for performing a task on the work piece. The control means operates to control the motor, and receives feedback from the gradation system which allows the control means to control the motor to locate the carriage and platform according to precise measurement determined according to the control means.

This form of the present invention can provide the following benefits:

a. The linear gauge is precision engineered from lightweight material.
b. The linear gauge is substantially non-weight bearing hence can be made from material such as aluminium,
c. Greater precision on linear gauge for locating a device for performing work in a work piece

In an operating condition, a device such as a workpiece can be mounted on the movable platform and the control means can accurately locate the device at precise measurements along the elongated frame according to the precision measurements of the linear gauge.

Forms of the present invention can provide the following benefits:
a. High accuracy | The most technologically advanced length stop system on the market, assuring high position accuracy time after time, year-after-year.
b. Simple to implement | Designed mechanically and ergonomically to be a bolt-on, plug-and-run system, even for the most sophisticated automation tasks.
c. High-value management | Designed for the simplest possible jobs management using technology to make cumbersome processes simple.

Also in embodiments of the invention there is provided:
I. Automatic length stop and feeder for saws, drills, presses and more.
II. High quality touch-screen with simple to use control interface.
III. ±0.1 mm positioning accuracy with the most advanced positioning functions.
IV. Enter & go to length, increment feed with blade kerf compensation, jog left/right.
V. Resettable cuts counter with job completed alert and blade change alert.
VI. Intelligent job management system. Save jobs as one-part or as bill-of-material
VII. (BOM) groups.
VIII. Simple wireless from-the-office job management. Create job lists in Excel then drag-and-drop or e-mail to the linear gauge system.
IX. 10,000+ jobs memory with edit, create, save, delete.
X. Intuitive from-the-console yield nesting. Your operator can cut yield maximised jobs without the hassle of managing stock. (optional)
XI. From-the-office stock management and nesting with drag-and-drop, or e-mailing of optimised cut lists to the linear gauge system. (optional)
XII. Automatic label printing or pin marking. (optional)
XIII. The most advanced safety features available:
XIV. Proprietary impact buffer system; not possible for operator to damage Linear gauge system from any size hit.
XV. Active impact detection system with auto-release. Safely removes jams every time.
XVI. Limit switch disabling the Linear gauge system when your saw is not in its home position.

Linear gauge system feeder is a simple to implement solution for fully automating repetitive pushing or pulling tasks on your presses, saws and drills. Convert your semi-automatic machinery into a production jet with a Linear gauge system feeder. This allows the user to:
A. Fully automate new or old semi-automatic saws, drills, presses and more.
B. Automatic cutting to length, or pressing drilling to a pitch on your existing machines.
C. Multiple times speed/productivity improvement with no operator required.
D. No setup, fully automated running. Just enter the length, put the material down, and press GO.
E. Automatic yield maximisation of your material with on-the-fly length measurement and cut list nesting. (optional)
F. Also use as a length stop, with full features of Linear gauge system length Stop (Advanced).
G. Complete auto-feeding solution for any machine. User friendly, simple to implement.
H. Integrate it yourself, or we can complete integration for you; at our factory or yours.
I. provide full turnkey automated solutions with Linear gauge system feeder and other machines specified and made to your production requirements.

Linear Gauge System| Special Applications

Linear gauge system length Stop and Feeder come optionally with automatic yield maximisation nesting. It is available as a stock management software solution for your office, or as a console-integrated solution for the floor. Linear gauge system yield nesting optimisation process is designed to be intuitive and simple to use, whether you manage it from the office or from the console.

From-the-office stock management software seamlessly integrates with Linear gauge system such that you can wirelessly drag-and-drop or e-mail optimised cut lists to the linear gauge system, where it is automatically loaded ready for the operator.

The improved system is designed so that yield nesting does not require cumbersome stock management. Simply measure the material length and enter it into the linear gauge system. It then optimizes the job list, all you have to do is cut. Measure next one, and repeat. You can also just select ‘continuous stock’ if your material lengths are all the same after which there is no measuring. With the Linear gauge system feeder, the material length is automatically measured by an optical sensor during feeding. So all your operator has to do is put the material on the table and press GO.

With Linear gauge system you can setup a drilling part file with an unlimited number of holes and hole position data. You can setup your job using either absolute position for each hole, or relative to the last hole, or a mix. With a push of a button, Linear gauge system moves the work piece to first hole position, with the hole information displayed for the operator (diameter, depth, etc.). Your operator simply drills with information provided, and goes on drilling using hole data, line by line. When all holes are drilled, Linear gauge system will alert the operator part has been completed. Accurately drilled, no mistakes, every time.

Have you got production requiring complex maths equations based on length?

Say for example you're producing fencing cross-bars where you must measure the bar length and then calculate how many holes you can place on the bar, often in a special pattern. Linear gauge system feeder automatically measures the lengths of the tubes placed on it and then can optionally be programmed to execute any mathematical equations you require for any hole pattern needed for production. This will be initiated during feeding and holes will be pressed according to the calculated pattern at high-speed, without delays. Accurately pressed, no mistakes, every time.

Have you got a cut-to-length business with many small-quantity jobs?

Set up your business operations with the Linear gauge system linked directly to your front counter. Cut data (profile types, lengths and quantity) can be sent wirelessly and automatically from the front counter to Linear gauge system at the execution of each sale. At the saw, operator reads the information for the job just sold on the Linear gauge system screen, fetches the correct stock, presses GO, and cuts the order. On job completion, operator presses ‘Job Complete’ and Linear gauge system alerts Goods Despatch (or the Customer) that the order is ready to go, in a fully integrated business operations system.

Linear gauge system Attachments

We have a range of standard and special-application attachments for any stop gauge or feeding requirement. Standard attachments not suitable? We can make any solution you need, and chances are that whatever you need, we've made before. If you want to make your own attachment, you can, many of our Customers do. Linear gauge system machines have a standardised three-bolt mount designed for easy attachment changeover.

### Interpretation

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to high precision location for cutting and lightweight construction gauge system.

1. A linear gauge system for locating adjacent a weight bearing elongated frame able to support an elongated product which is to be processed linearly, the linear gauge system comprising:
a. a linear gauge, wherein the linear gauge is made precisely from a lightweight material;
b. an elongated support wherein the elongated support is formed of stronger material than the linear gauge; and
c. a carriage mounted on the linear gauge to which is mounted a movable platform which can engage a workpiece on the adjacent weight bearing elongated frame;
wherein the linear gauge is formed precisely separately to the elongated support and mounted to the elongated support to provide the strength to the linear gauge.

2. (canceled)

3. (canceled)

4. (canceled)

5. A linear gauge system according to claim 4 wherein the linear gauge is made precisely from predominately aluminium, wherein the elongated support is formed of steel, and wherein the elongated support is formed by at least two sections as a strong hollow structure by at least two sections such as L sections that interfit to form the hollow structure.

6. A linear gauge system according to claim 1 wherein the linear gauge is mounted at least substantially within the elongated support, and wherein the carriage is generally inverted U-shape over the linear gauge and within the elongated support and engaging by bearings therebetween.

7. (canceled)

8. A linear gauge system, for locating adjacent a weight bearing elongated frame able to support an elongated product which is to be processed linearly, the linear gauge system comprising:
a linear gauge having precision measurements mounted on an elongate support, the elongate support including a longitudinal slot;
a carriage movably mounted on the linear gauge;
a movable platform connected to the carriage, the platform having a portion protruding through the slot, the protruding portion adapted to receive and support a workpiece adjacent the support;
a drive means connected to the movable platform for driving the movable platform and the connected carriage to precise locations along the linear gauge;
a control means for controlling the movement of the platform along the platform according to the required precise measurement;
wherein the movable platform is adapted to cooperate with a device such as a cutting device mounted at a fixed relative position, and the control means locates the device at precise measurements along the weight bearing elongated frame according to the precision measurements of the linear gauge.

9. (canceled)

10. A linear gauge system according to claim 8 wherein the drive means is offset but partially overlapping the carriage, and wherein the drive means includes a drive motor remote from the platform and able to drive the platform by a drive belt.

11. (canceled)

12. (canceled)

13. A linear gauge system according to claim 8 wherein the drive means includes a drive belt, the drive belt is a continuous loop belt connecting to opposite sides of the platform, and wherein the continuous loop overlaps above and below the carriage.

14. (canceled)

15. (canceled)

16. A linear gauge system comprising:
a linear gauge having precision measurements;
a weight bearing elongated frame located adjacent to the linear gauge;
a movable platform mounted on the weight bearing frame enabling travel along the weight bearing elongated frame;
a drive means for driving the movable platform;
a control means for controlling the movement of the platform along the platform according to precise measurement determined according to the linear gauge;
wherein the movable platform is adapted to receive a device such as a cutting device mounted thereon, and the control means locates the device at precise measurements along the weight bearing elongated frame according to the precision measurements of the linear gauge.

17. A linear gauge system according to claim 16 wherein the weight bearing elongated frame is located offset from and below the linear gauge, and wherein the linear gauge is precision engineered from aluminium.

18. (canceled)

19. (canceled)

20. A linear gauge system according to claim 16 wherein the linear gauge is mounted on the weight bearing elongated frame, and wherein the weight bearing elongated frame substantially encloses the linear gauge.

21. (canceled)

22. (canceled)

23. (canceled)

24. (canceled)

25. A linear gauge system according to claim 16 wherein the movable platform is mounted to a linear gauge carriage, and wherein the linear gauge carriage is adapted to receive a cross-section of the weight bearing elongated frame to enable travel along the elongated frame.

26. A linear gauge system according to claim 25 wherein a portion of the movable platform extends away from the weight bearing frame and supports the device mounted on the carriage.

27. A linear gauge system according to claim 16 wherein the movable platform is mounted to a linear gauge carriage travelling along the linear gauge in a substantially non-weight bearing manner enabling precision travel along the linear gauge.

28. A linear gauge system according to claim 27 wherein the linear gauge carriage substantially overlies the linear gauge.

29. A linear gauge system according to claim 27 wherein the linear gauge carriage is a substantially inverted U-shape which overlies the linear gauge.

30. A linear gauge system according to claim 27 wherein the linear gauge carriage substantially glides along the linear gauge.

31. A linear gauge system according to claim 27 wherein the linear gauge carriage substantially glides along the linear gauge along elongated bearings.

32. A linear gauge system according to claim 16 wherein the drive means is mounted on the movable platform to drive it along the weight bearing frame.

33. A linear gauge system according to claim 16 wherein the drive means is mounted on the weight bearing frame and connected to the movable platform to drive it along the weight bearing frame.

34. A linear gauge system according to claim 16 wherein the drive means is mounted alongside the weight bearing frame and includes a motor driving an elongated member connected to the movable platform to selectively locate the movable platform along the weight bearing frame.

35. A linear gauge system according to claim 16 wherein the drive means is mounted to the weight bearing frame and includes a motor driving an elongated member extending in a continuous loop around spigots at or near spaced ends of the weight bearing frame and connected to opposing sides of the movable platform to selectively locate the movable platform along the weight bearing frame.
